(19) United States
(12) Patent Application Publication
(10) Pub. No.: US 2013/0102230 A1
(43) Pub. Date: Apr. 25, 2013

(54) Method of Manufacturing Glass Substrate for Information Recording Medium, and Suction Instrument

(71) Applicants: Takafumi Komatsu, Tokyo (JP); Ryota Ushijima, Osaka (JP); Kazuya Aoki, Osaka (JP)

(72) Inventors: Takafumi Komatsu, Tokyo (JP); Ryota Ushijima, Osaka (JP); Kazuya Aoki, Osaka (JP)

(21) Appl. No.: 13/807,832

(22) PCT Filed: Jun. 21, 2011
(86) PCT No.: PCT/JP2011/003546

§ 371 Date: Dec. 31, 2012

(30) Foreign Application Priority Data
Jun. 30, 2010 (JP) 2010-148937

(51) Int. Cl. B24B 37/34; B25J 15/06

(52) U.S. Cl. CPC B24B 37/345; B25J 15/0616
USPC 451/41; 294/183

(57) ABSTRACT

An object of the invention is to provide a method of manufacturing a glass substrate for an information recording medium, which suppresses an increase in the number of foreign matter adhering to the surface of the glass substrate or damages on the surface of the glass substrate in suckingly holding the glass substrate by a suctorial holding portion, and to provide a suction instrument which makes it easy to dismount a glass substrate from a polishing pad of a polishing device. A suction instrument 1 of the invention has a suction pad 32. The suction pad 32 is provided with a center hole 32a, and a groove 32b extending from the center hole 32a to an end of an outer periphery of the contacting pad 32.

### TECHNICAL FIELD

The present invention relates to a method of manufacturing a glass substrate for an information recording medium, and a suction instrument for suckingly holding a member to be sucked by applying a negative pressure, and more particularly to a suction instrument suitable for suckingly holding a glass substrate for an information recording medium.

### BACKGROUND ART

An aluminum alloy substrate or a glass substrate polished by a polishing device having a polishing pad is used as a substrate in a magnetic disk recording device for use in e.g. a computer, such as a hard disk. A metal magnetic film is formed on the polished substrate, and information is recorded by magnetizing the metallic magnetic film by a magnetic head. Conventionally, in the process of polishing such a glass substrate for an information recording medium, in taking out the glass substrate for an information recording medium polished by the polishing pad of the polishing device from the polishing device, the glass substrate for an information recording medium is taken out by the operator's hand(s). Since the glass substrate for an information recording medium may stick to the polishing pad by e.g. a polishing liquid, it is difficult to dismount the glass substrate for an information recording medium from the polishing pad by the hand(s). Further, in dismounting the glass substrate for an information recording medium, the surface of the glass substrate for an information recording medium may be damaged, or coagulated abrasion particles or foreign matter such as bacteria may be adhered to the surface of the glass substrate for an information recording medium.

In view of the above, a suction instrument for taking out a glass substrate for an information recording medium from a polishing pad of a polishing device is disclosed in e.g. patent literature 1. The suction instrument disclosed in patent literature 1 is configured in such a manner that a suctorial holding portion (suctorial holding surface) having a contacting pad is contacted with the surface of a glass substrate for an information recording medium for sucking the glass substrate for an information recording medium through a suction port (suction hole) formed in the suctorial holding portion to thereby suckingly hold the glass substrate for an information recording medium by the suctorial holding portion. By performing the above operation, it is possible to take out the glass substrate for an information recording medium from the polishing device.

However, the suction instrument disclosed in patent literature 1 has a problem that the number of foreign matter adhering to the surface of a glass substrate for an information recording medium intolerably increases, resulting from suckingly holding the glass substrate for an information recording medium by the suctorial holding portion of the suction instrument. As a result of conducting detailed researches on the above phenomenon by the applicant of the present application, it has been concluded that the above problem arises from an operation of taking out a glass substrate for an information recording medium with use of the suction instrument as disclosed in patent literature 1.

More specifically, for instance, as shown in FIG. 12, in the case where a glass substrate 100 for an information recording medium is sucked by a suction instrument “a” through a suction port “c” formed in a suctorial holding portion “b” of the suction instrument “a”, the air in a through-hole 101 of the glass substrate 100 is also sucked in suckingly holding the glass substrate 100 for an information recording medium, with the result that a polishing pad 111 may be also sucked through the through-hole 101. In such a case, it is necessary to increase the suction force by the suction instrument “a” in dismounting the glass substrate 100 for an information recording medium from the polishing pad 111. As a result, a strong pressing force may be exerted between the glass substrate 100 for an information recording medium and the suctorial holding portion “b”. In such a case, foreign matter carried by the suctorial holding portion “b” may be fixedly adhered to the surface of the glass substrate 100 for an information recording medium, which makes it impossible or difficult to remove the foreign matter even by washing. As a result, a large amount of adhered foreign matter may remain on the surface of the glass substrate 100 for an information recording medium.

Further, in the case where the air in the through-hole 101 is sucked, the interior of the through-hole 101 is brought to a vacuum state. In such a condition, the polishing pad 110 may be deteriorated, or a polishing liquid or abrasion particles staying in the through-hole 101 may be sucked and pass through the through-hole 101 toward the suction port “c” between the glass substrate 100 for an information recording medium and the suctorial holding portion “b”. This may cause damages on the surface of the glass substrate 100 for an information recording medium or fixed adhesion of foreign matter onto the surface of the glass substrate 100 for an information recording medium.

Furthermore, since the glass substrate 100 for an information recording medium is suckingly held by the polishing pad 111 of the polishing device 110 through the through-hole 101, it is difficult to dismount the glass substrate 100 for an information recording medium from the polishing pad 111 of the polishing device 110. This may cause dropping of the glass substrate 100 for an information recording medium in dismounting the glass substrate 100 for an information recording medium, or generation of damages or adhesion of foreign matter resulting from deterioration of the polishing pad 111.

### CITATION LIST

### Patent Literature

Patent literature 1: JP 2007-216311A

### SUMMARY OF INVENTION

An object of the invention is to provide a method of manufacturing a glass substrate for an information recording medium, which suppresses an increase in the number of foreign matter adhering to the surface of the glass substrate for an information recording medium, or suppresses an increase in damages on the surface of the glass substrate for an information recording medium, in suckingly holding the glass substrate for an information recording medium by a suctorial holding portion; and a suction instrument that makes it easy to dismount a glass substrate for an information recording medium from a polishing pad of a polishing device.

In view of the above, a method of manufacturing a glass substrate for an information recording medium according to an aspect of the invention is a method of manufacturing a glass substrate for an information recording medium, the glass substrate for an information recording medium having a disc shape and formed with a through-hole in a center portion thereof. The method includes a step of polishing a surface of a disc-shaped glass member formed with a through-hole in a center portion thereof by a polishing device to form a glass substrate for an information recording medium; and a step of contacting the polished glass substrate for an information recording medium with a suction instrument, and taking out the glass substrate for an information recording medium from the polishing device in a state that the glass substrate for an information recording medium is sucked by the suction instrument. The suction instrument is provided with a suction instrument main body having a suction air passage to be suckingly connected to a suction device, and a suctorial holding portion having a suction port communicating with the suction air passage, the suctorial holding portion being integral with the suction instrument main body. In the step of taking out the glass substrate for an information recording medium from the polishing device, the glass substrate for an information recording medium is sucked by the suctorial holding portion through the suction port of the suctorial holding portion via the suction air passage in response to activation of the suction device in a contacted state that the suctorial holding portion is contacted with the glass substrate for an information recording medium, whereby the glass substrate for an information recording medium is suckingly held by the suctorial holding portion. The suction instrument is configured to communicate between the through-hole formed in the glass substrate for an information recording medium and the exterior in the contacted state.

In the above configuration, the suction instrument is configured in such a manner that the through-hole formed in the glass substrate for an information recording medium is communicated with the exterior in a state that the suctorial holding portion is contacted with the glass substrate for an information recording medium. Accordingly, it is possible to draw the air into the through-hole of the glass substrate for an information recording medium, in the case where the air in the through-hole is sucked through the suction port in suckingly holding the glass substrate for an information recording medium by the suctorial holding portion. This is advantageous in suppressing suctorial adhesion between the glass substrate for an information recording medium and the polishing pad of the polishing device. Thus, the manufacturing method and the suction instrument having the above configuration are advantageous in avoiding intolerable suctorial adhesion of the glass substrate for an information recording medium onto the suctorial holding portion, and are advantageous in suppressing fixed adhesion and residue of foreign matter carried by the suctorial holding portion on the surface of the glass substrate for an information recording medium. Further, the manufacturing method and the suction instrument having the above configuration are advantageous in easily taking out the glass substrate for an information recording medium from the polishing pad of the polishing device.

These and other objects, features and advantages of the present disclosure will become more apparent upon reading the following detailed description along with the accompanying drawings.

### BRIEF DESCRIPTION OF DRAWINGS

FIG. 1 is a front view of a suction instrument in a first embodiment of the invention;

FIG. 2 is a bottom view of FIG. 1;

FIG. 3 is a sectional view taken along the line III-III in FIG. 2;

FIG. 4 is a sectional explanatory view in suckingly holding a glass substrate for an information recording medium by the suction instrument in the first embodiment;

FIG. 5 is an explanatory view showing a state that a suctorial holding portion is displaced with respect to a glass substrate for an information recording medium;

FIG. 6 is a front view of a suction instrument in a second embodiment of the invention;

FIG. 7 is a bottom view of FIG. 6;

FIG. 8 is a sectional view taken along the line VIII-VIII in FIG. 7;

FIG. 9 is a table showing the number of batches included in each respective stage corresponding to a yield of good products of glass substrates for information recording media, based on the number of foreign matter adhering to the glass substrates in using each of the suction instrument in the first embodiment and a suction instrument as a comparative example, in the case where the yields are classified into ten stages;

FIG. 10 shows an example of a graph created based on the batch numbers shown in FIG. 9;

FIG. 11 is a table showing an example of the counted numbers of foreign matter (particles) adhering to four glass substrates for information recording media which are suckingly held by each of the suction instrument in the first embodiment and a suction instrument as a comparative example; and

FIG. 12 is a sectional explanatory view in suckingly holding a glass substrate for an information recording medium by a suction instrument without an air passage for external communication.

### DESCRIPTION OF EMBODIMENTS

In the following, embodiments of the invention are described referring to the accompanying drawings. In the drawings, elements with the same reference signs indicate the elements substantially identical or equivalent to each other, and a repeated description thereof is omitted, as necessary.

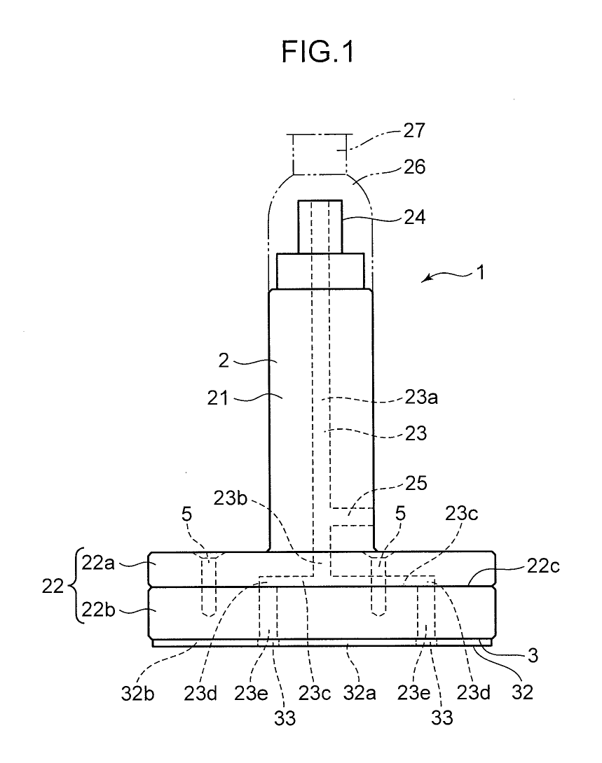

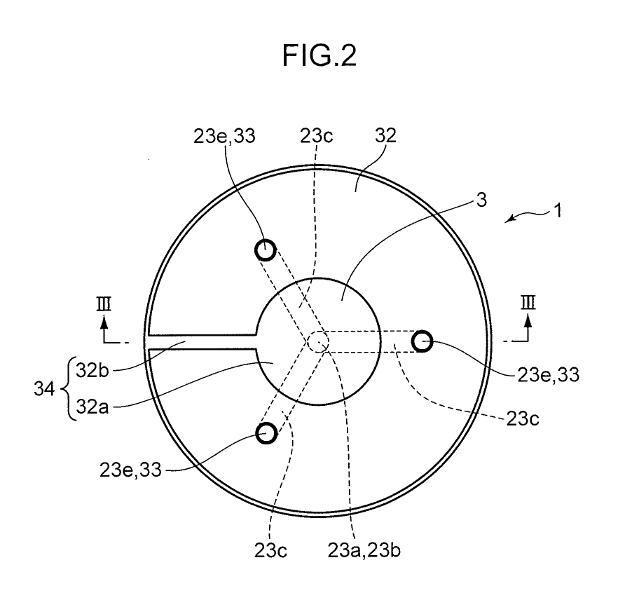

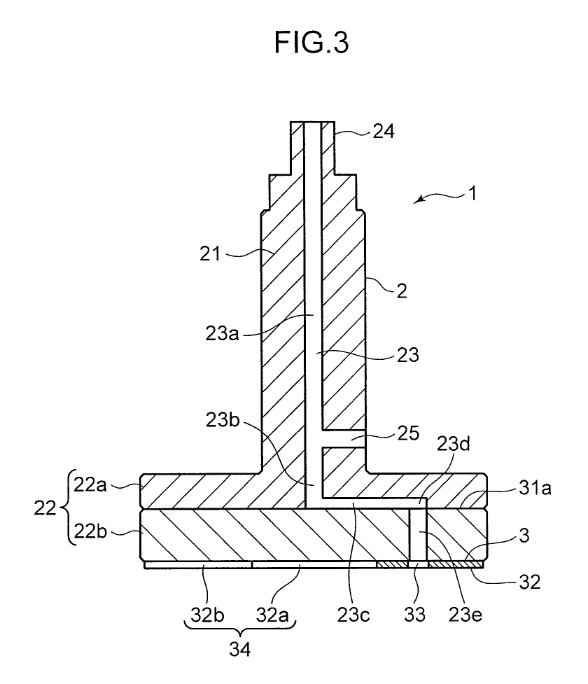

FIG. 1 is a front view of a suction instrument in the first embodiment of the invention. FIG. 2 is a bottom view of FIG. 1. FIG. 3 is a sectional view taken along the line in FIG. 2.

The suction instrument 1 in the first embodiment is provided with a suction instrument main body 2, and a suctorial holding portion 3. The suction instrument main body 2 is provided with a holding portion 21 and a suctorial operation portion 22.

The holding portion 21 is formed of a column-shaped member having a diameter capable of being held by the operator's hand. Further, a holding communication hole 23a is formed in a shaft portion inside the holding portion 21. The holding communication hole 23a extends along the axis direction of the shaft portion and passes through both ends of the shaft portion in the axis direction for allowing passage of a fluid therethrough.

Further, a suction device connecting portion 24 is formed at a first end (an upper end in FIG. 1) of the holding portion 21 in the axis direction. The suction device connecting portion 24 is connected to a connection member 26 of a connection hose 27 of a suction device (not shown). With this arrangement, the holding communication hole 23a is suckingly connected to the suction device.

Further, an openable and closable operation hole 25 is formed in an outer circumferential surface of the holding portion 21. The openable and closable operation hole 25 passes from the outer circumferential surface to the holding communication hole 23a. In this embodiment, the openable and closable operation hole 25 is formed to have such a size as to be closable by the operator's finger.

The suctorial operation portion 22 is formed of a disc-shaped member whose diameter is set larger than the diameter of the holding portion 21. The suctorial operation portion 22 is connected to a second end (a lower end in FIG. 1) of the holding portion 21 in the axis direction. The second end of the holding portion 21 corresponds to the other end of the holding portion 21 in the axis direction, which is different from the first end of the holding portion 21. In this embodiment, the suctorial operation portion 22 is constituted of two portions i.e. a first suctorial operation portion 22a which is integral with the holding portion 21, and a second suctorial operation portion 22b which is mounted on the first suctorial operation portion 22a.

A retaining communication hole 23b is formed in the first suctorial operation portion 22a. A first end (an upper end in FIG. 1) of the retaining communication hole 23b is communicated with the holding communication hole 23a.

Three branching holes 23c are formed at a second end (a lower end in FIG. 1) of the retaining communication hole 23b. The branching holes 23c are respectively formed to extend from the retaining communication hole 23b radially outwardly. The branching holes 23c are circumferentially and equidistantly spaced apart from each other. In this embodiment, the branching hole 23c extends to a perimeter of a circle whose diameter is substantially equal to 40 mm with respect to an axis of rotation of the first suctorial operation portion 22a as a center. Branching hole ends 23d are formed on the perimeter of the circle.

The second suctorial operation portion 22b is formed of a disc-shaped member whose diameter is substantially equal to the diameter of the first suctorial operation portion 22a. Further, a first end (an upper end in FIG. 1) of the second suctorial operation portion 22b in the axis direction constitutes a connecting portion 22c to be connected to the first suctorial operation portion 22a. On the other hand, the suctorial holding portion 3 to be described later is formed at a second end (a lower end in FIG. 1) of the second suctorial operation portion 22b in the axis direction. The second end of the second suctorial operation portion 22b corresponds to other end of the second suctorial operation portion 22b in the axis direction, which is different from the first end of the second suctorial operation portion 22b.

Further, three suction through-holes 23e are formed in the second suctorial operation portion 22b along the axis direction. The suction through-holes 23e respectively pass from the connecting portion 22c to the suctorial holding portion 3. These suction through-holes 23e are formed at positions corresponding to the branching hole ends 23d of the branching holes 23c of the first suctorial operation portion 22a.

The thus constructed second suctorial operation portion 22b is connected to the first suctorial operation portion 22a via the connecting portion 22c. The first and second suctorial operation portions 22a and 22b are fixedly connected to each other in the above state via bolts 5. Further, in the connection state, the suction through-holes 23e and the branching hole ends 23d of the branching holes 23c of the suctorial holding portion 22 coincide with each other and are communicated with each other.

In the above configuration, the three through-holes 23e, the retaining communication hole 23b, and the holding communication hole 23a are communicated with each other, whereby a suction air passage 23 is formed.

As described above, the suctorial holding portion 3 is formed at an end surface of the second end of the second suctorial operation portion 22b. Further, in this embodiment, the suctorial holding portion 3 is provided with a contacting pad 32. The contacting pad 32 is formed of a circular shaped (disc-shaped) member having an outer diameter (in this embodiment, 49 mm) substantially equal to the outer diameter of the suctorial operation portion 22. Further, the contacting pad 32 is formed with three suction ports 33, a center hole 32a serving as a communication port, and a groove 32b serving as a communication path.

The suction ports 33 are respectively formed at positions corresponding to the through-holes 23e of a suctorial holding portion main body 31.

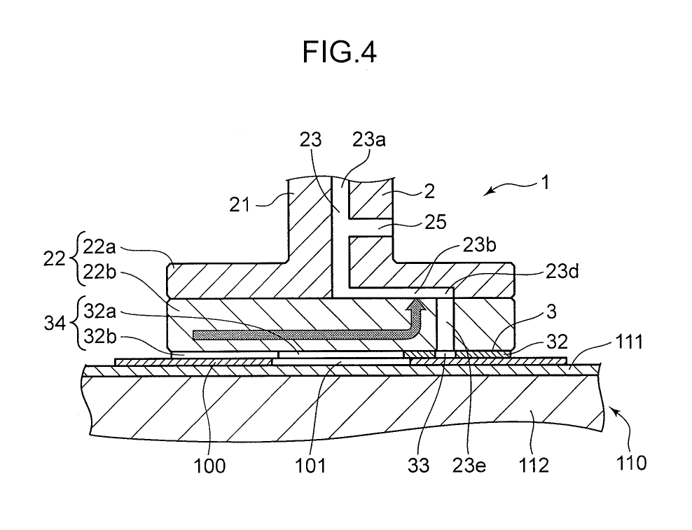

In this embodiment, the center hole 32a is formed to have a size substantially equal to or slightly larger than the size of a through-hole 101 (see FIG. 4) of a glass substrate 100 for an information recording medium, which will be described later. Accordingly, the center hole 32a is disposed at a radially inward position of the suction ports 33.

In this embodiment, the groove 32b has a width as small as about 2 mm. The groove 32b is formed by partially cutting away the contacting pad 32 in a region from the center hole 32a to an end of an outer periphery of the contacting pad 32. The groove 32b and the center hole 32a constitute an air passage 34 for external communication.

The contacting pad 32 is mounted on the second end of the second suctorial operation portion 22b. In the mounted state, the suction ports 33 of the contacting pad 32 respectively coincide with the suction through-holes 23e of the suction air passage 23 in the suction instrument main body 2, and are communicated with the through-holes 23e.

In this embodiment, the contacting pad 32 is cut away with use of a compass cutter to avoid burrs which may be formed on the contacting pad 32. Further, the suction ports 33 are formed by a hole puncher.

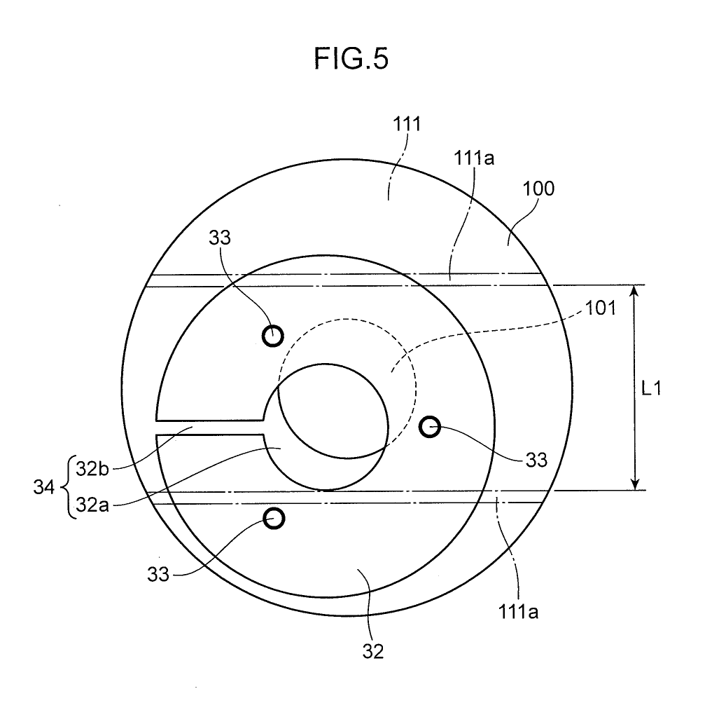

The material of the contacting pad 32 is not specifically limited. Preferably, however, the material of the contacting pad 32 may be the same as the material of a polishing pad 111 (see FIG. 4) of a polishing device 110 to be described later. The above configuration is advantageous in suppressing damages of the glass substrate 100 for an information recording medium (see FIG. 4 and FIG. 5) in suckingly supporting the glass substrate 100 for an information recording medium, and in suppressing damage of the polishing pad 111, even in the case where the contacting pad 32 is contacted with the polishing pad 111. Further preferably, the hardness of the contacting pad 32 may be an Asker hardness 75 or less.

The thus constructed suction instrument 1 is used in e.g. suckingly holding a glass substrate for an information recording medium as a member to be sucked, and taking out the glass substrate for an information recording medium from a polishing device in a polishing step in a glass substrate for an information recording medium manufacturing process.

The glass substrate 100 for an information recording medium as a member to be sucked is a doughnut-shaped (annular-shaped) disc member having a through-hole 101, as shown in FIG. 4 and FIG. 5. The glass substrate 100 for an information recording medium has 65 mm in outer diameter, 20 mm in inner diameter, and 0.635 mm in plate thickness, for instance.

Further, a method of manufacturing a glass substrate for an information recording medium in the embodiment may have the following steps. Firstly, a plate-shaped glass member in the form of a disc and having a through-hole 101 is formed. Then, a wrapping step of wrapping a surface of the plate-shaped glass member is performed. Then, there is performed a polishing step constituted of two steps i.e. a rough polishing step of roughly polishing the wrapped surface with use of a polishing device, and a fine polishing step of polishing the surface of the plate-shaped glass member, which has been polished in the rough-polishing step for obtaining a smaller surface roughness so as to form a glass substrate for an information recording medium. Then, a taking-out step of taking out the glass substrate for an information recording medium polished in the fine polishing step from the polishing device is performed. Then, a washing step of washing the taken-out glass substrate for an information recording medium is performed.

Further, as shown in FIG. 4, the polishing device 110 to be used in the fine polishing step is provided with e.g. a lower surface plate 112 and an unillustrated upper surface plate. A polishing pad 111 is disposed on the top surface of the lower surface plate 112. Further, although not shown, a polishing pad substantially having the same construction as the polishing pad 111 is disposed on the bottom surface of the upper surface plate.

A plate-shaped raw glass plate 100 is placed between the polishing pad 111 of the lower surface plate 112 and the polishing pad of the upper surface plate. In this embodiment, the polishing device 110 is operable to place one hundred plate-shaped raw glass plates 100 simultaneously, and to polish one hundred plate-shaped raw glass plates 100 by one batch process.

After the plate-shaped raw glass plates 100 are placed, the lower surface plate 112 and the upper surface plate are rotated relative to each other, while a polishing liquid being supplied between the lower surface plate 112 and the upper surface plate. By performing the above operation, the surfaces of the glass substrates 100 for information recording media are polished by the two polishing pads 111.

Next, an operation to be performed by the suction instrument 1 in the first embodiment is described. The description is made based on an example, in which glass substrates 100 for an information recording medium polished by the polishing device 110 to be used in the fine polishing step are taken out from the polishing device 110.

For instance, as shown in FIG. 4, the operator contacts the contacting pad 32 of the suctorial holding portion 3 of the suction instrument 1 with the surface of a glass substrate 100 for an information recording medium which has been polished by the polishing device 110, and is placed on the polishing pad 111 of the lower surface plate 112 in a state that the suction device is connected to the suction device connecting portion 24 of the suction instrument 1, and the suction device is activated.

By performing the above operation, the through-hole 101 of the glass substrate 100 for an information recording medium and the exterior are communicated with each other via the center hole 32a and the groove 32b of the contacting pad 32 constituting the air passage 34 for external communication.

In performing the above operation, it is possible to contact the entire surface of the glass substrate 100 for an information recording medium with the contacting pad 32 in such a manner that the center of the contacting pad 32 coincides with the center of the glass substrate 100 for an information recording medium. However, as shown in e.g. FIG. 5, the suction instrument 1 in this embodiment is operable to communicate between the through-hole 101 of the glass substrate 100 for an information recording medium and the exterior with each other via the center hole 32a and the groove 32b while partially overlapping the through-hole 10 of the glass substrate 100 for an information recording medium and the center hole 32a, even in the case where the center of the contacting pad 32 is displaced from the center of the glass substrate 100 for an information recording medium to some extent.

Accordingly, even in the case where it is difficult to accurately grasp the position of a glass substrate 100 for an information recording medium placed on the polishing pad 111 of the lower surface plate 112 due to e.g. reflection of a polishing liquid, the suction instrument 1 in this embodiment is advantageous in easily communicating between the through-hole 10 of the glass substrate 100 for an information recording medium and the exterior with each other via the center hole 32a and the groove 32b.

Then, the operator closes the operation hole 25 with e.g. the operator's finger in the above state. By performing the above operation, the glass substrate 100 for an information recording medium is suckingly adhered to the contacting pad 32 through the suction ports 33 via the suction air passage 23.

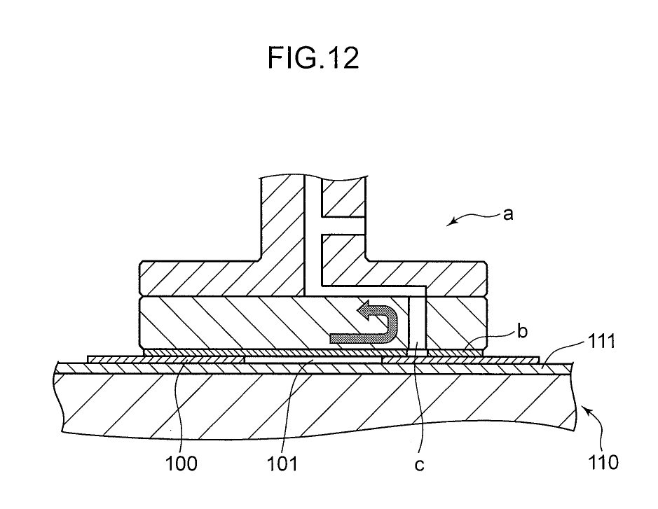

In the case where a contacting pad 32 is distorted resulting from pressing and/or aging deterioration in using a suction instrument without an air passage for external communication as shown in e.g. FIG. 12, a clearance may be formed between the glass substrate 100 for an information recording medium and the contacting pad 32. In a worse case, in suckingly holding a glass substrate 100 for an information recording medium, the air in the through-hole 101 of the glass substrate 100 for an information recording medium may also be sucked, and the polishing pad 111 may be sucked through the through-hole 101.

However, in this embodiment, the suction instrument 1 is configured to draw the air into the through-hole 101 via the center hole 32a and the groove 32b constituting the air passage 34 for external communication. This is advantageous in suppressing sucking of the polishing pad 111 through the suction ports 33 and the through-hole 101.

Accordingly, the suction instrument 1 in this embodiment is advantageous in suppressing adhesion of foreign matter carried by the contacting pad 32 onto the surface of the glass substrate 100 for an information recording medium. Further, the suction instrument 1 in this embodiment is advantageous in easily dismounting the glass substrate 100 for an information recording medium from the polishing pad 111.

Further, plural concave grooves 111a are formed in the surface of the polishing pad 111 of the lower surface plate 112 of the polishing device 110, as shown by e.g. the one-dotted chain line in FIG. 5. The polishing pad 111 may be sucked through the through-hole 101 in the manner as described above in the case where the interval L1 between adjacent concave grooves 111a is set larger than the diameter of the through-hole 101, and the glass substrate 100 for an information recording medium is placed on the polishing pad 111, which may result in complete blocking of the through-hole 101 substantially without a clearance from a lower side in FIG. 5 (from one side of the glass substrate 100 for an information recording medium) in a region between the concave grooves 111a; or in the case where no concave groove 111a is formed in the polishing pad 111. The suction instrument 1 in this embodiment, however, is advantageous in avoiding such a drawback by provision of the air passage 34 for external communication. Thus, the suction instrument 1 in this embodiment is advantageous in using various types of polishing pads in the polishing device 110, which provides convenient use of the polishing device 110.

The inventors of the present application conducted inspection of foreign matter on glass substrates 100 for information recording media, which have been taken out from the polishing device with use of the suction instrument 1 in the first embodiment. The following is a description on the inspection.

Firstly, forty-eight batches were performed to carry out fine polishing of glass substrates subjected to rough polishing by a well-known method, wherein each one hundred glass substrates were processed as one batch. In the fine polishing, colloidal silica having an average particle diameter of about 20 nm was used. The glass substrates were taken out from the polishing device, with use of the suction instrument 1 (inventive example) in the first embodiment. The taken-out glass substrates for information recording media were subjected to ultrasonic washing with use of a washing liquid, rinsing, and surface treatment with use of hydrofluoric acid. Then, the surfaces of the thus obtained glass substrates for information recording media were checked by a surface inspection apparatus SSI-640 (manufactured by System Seiko Co., Ltd) using an He—Ne laser light source, and a yield of good products of glass substrates for information recording media was obtained with respect to each of the forty-eight batches, based on the numbers of foreign matter adhered to the surfaces of the glass substrates for information recording media.

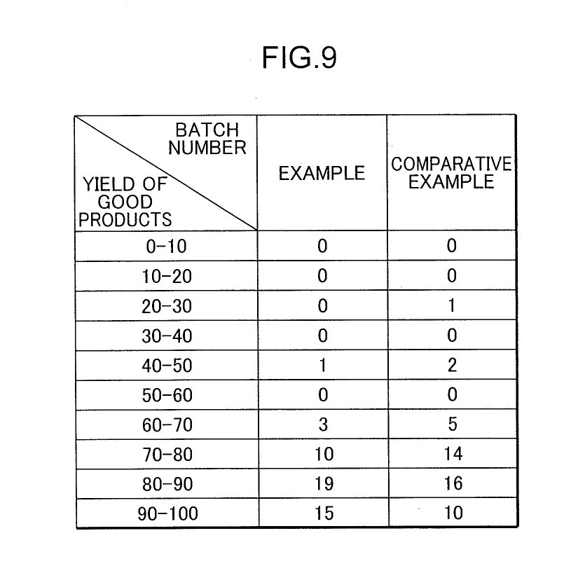

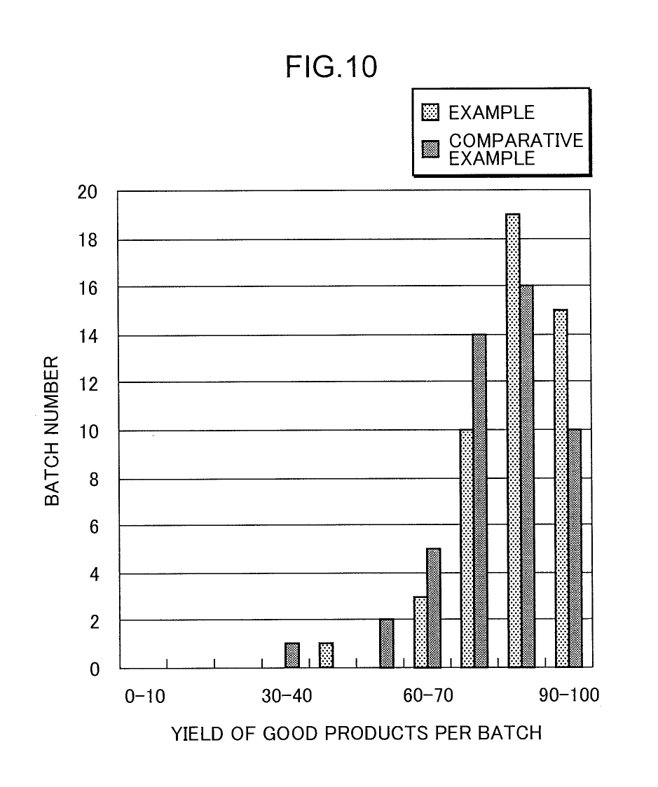

The inspection result was evaluated by classifying the yields of good products into ten stages, showing the number of batches included in each of the stages by way of numerical values in FIG. 9, and creating a bar graph as shown in FIG. 10 based on the numerical values shown in FIG. 9 (see inventive example in FIG. 10).

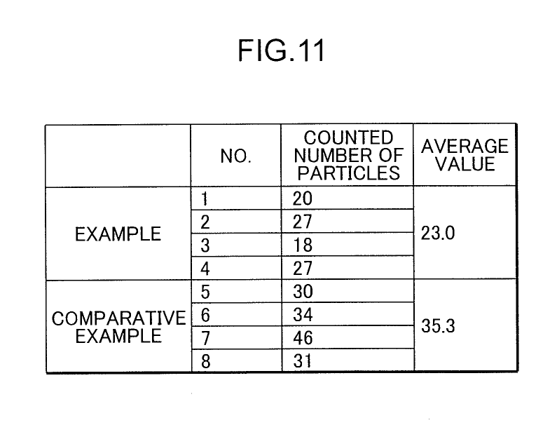

Further, four glass substrates for information recording media were randomly selected from the glass substrates for information recording media which have undergone the aforementioned washing step. Each four glass substrates were observed by a surface defect inspection apparatus OSA-6300 (manufactured by KLA). As shown in FIG. 11, the numbers of adhered foreign matter (particles) were counted, and the types of the foreign matter were identified by e.g. an atomic force microscope. A result of the inspection shows that the foreign matter is mainly composed of silica.

Further, as a comparative example, a suction instrument without an air passage for external communication was manufactured, and yields of good products of glass substrates for information recording media were also obtained in the same manner as described above, with use of the suction instrument as the comparative example. The suction instrument as the comparative example is substantially the same as the suction instrument in the first embodiment except that an air passage for external communication is not formed, and the suction instrument as the comparative example is substantially equivalent to the one shown in FIG. 12.

As shown in FIG. 9 and FIG. 10, the inspection result shows that as compared with the comparative example, the number of batches showing a high yield of good products was large in the case where the suction instrument 1 in the first embodiment was used. Further, as shown in FIG. 11, it was verified that the number of adhered foreign matter (particles) was small, and adhesion of silica was significantly suppressed in the case where the suction instruction 1 in the first embodiment was used.

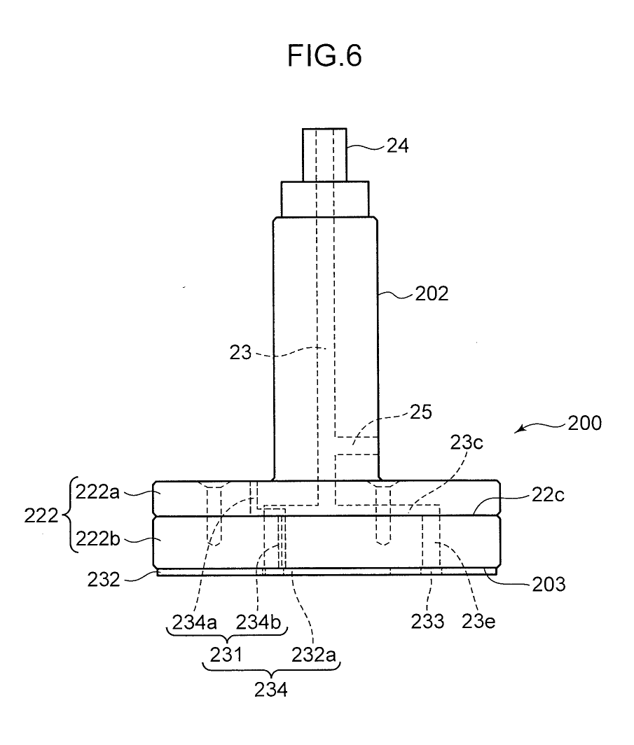

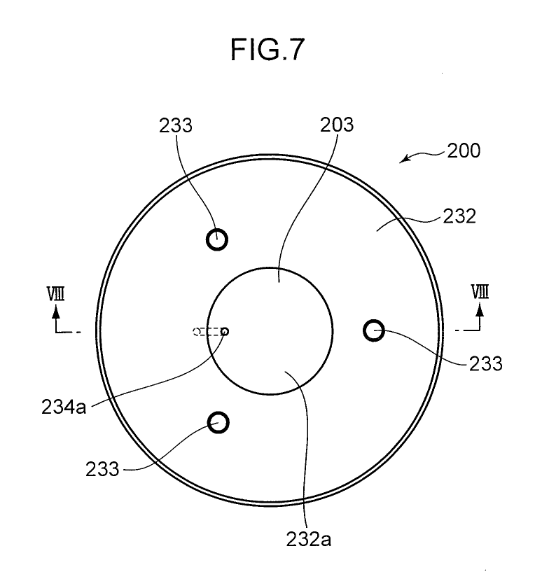

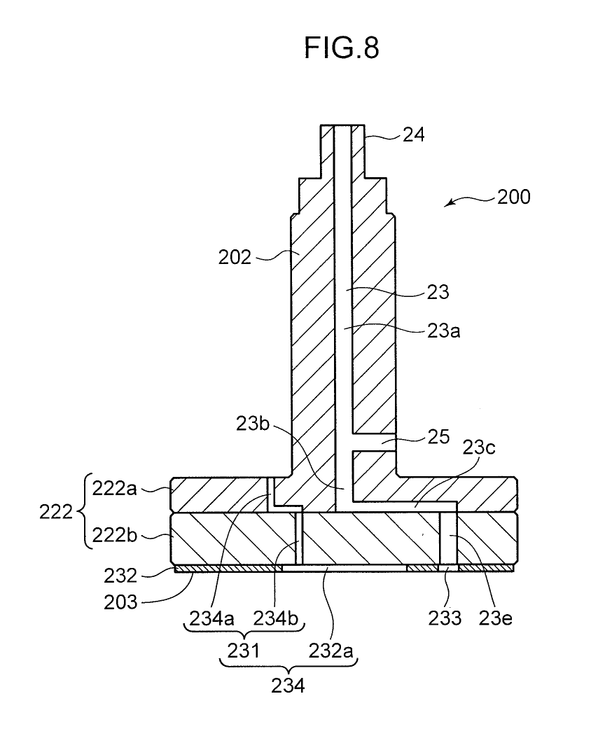

Next, a suction instrument 200 in the second embodiment is described referring to FIGS. 6 through 8. A contacting pad 232 of a suctorial holding portion 203 of the suction instrument 200 in the second embodiment is provided with three suction ports 233, and a center hole 232a in the same manner as in the first embodiment. However, the contacting pad 232 in the second embodiment is not provided with a member corresponding to the groove 32b of the contacting pad 32 in the first embodiment.

Further, a suctorial operation portion 222 of a suction instrument main body 202 of the suction instrument 200 is formed with a main body communication hole 231, as a communication path for communicating between the center hole 232a and the exterior. The main body communication hole 231 is constituted of a first main body communication hole 234a formed in a first suctorial operation portion 222a of the suctorial operation portion 222, and a second main body communication hole 234b formed in a second suctorial operation portion 222b of the suctorial operation portion 222.

The second main body communication hole 234b is formed to communicate with the center hole 232a. Further, the first main body communication hole 234a is formed to communicate between the second main body communication hole 234b and the exterior. The second main body communication hole 234b faces the exterior at a top surface of the first suctorial operation portion 222a. The main body communication hole 231 which is constituted of the first main body communication hole 234a and the second main body communication hole 234b, and the center hole 232a constitute an air passage 234 for external communication. The other elements in the second embodiment are substantially the same as those in the first embodiment.

In this embodiment, a suctorial holding portion is provided with a contacting pad. Further, the contacting pad is formed with a center hole and a groove serving as an air passage for external communication, or the contacting pad is formed with a center hole constituting a part of an air passage for external communication. The above configuration may be changed, as necessary.

For instance, the suctorial holding portion may be configured without a contacting pad, and a second end of the second suctorial operation portion may be formed with a circular-shaped concave portion, and with a groove extending from the concave portion to the end of the outer periphery of the second suctorial operation portion.

In this embodiment, the center hole is formed to have substantially the same size as the size of the through-hole of the glass substrate for an information recording medium. The size of the center hole is not specifically limited, but may be substantially equal to the width of the groove, for instance.

In the case where a contacting pad is provided, the size of the contacting pad is not specifically limited. The size of the contacting pad may be set larger or smaller than the outer diameter of the glass substrate for an information recording medium. Further, in the case where a groove is formed in the contacting pad, the width of the groove may also be changed, as necessary. Furthermore, two or more grooves may be formed. The number of the grooves may be also changed, as necessary.

In the foregoing embodiments, the suction instrument 1, 200 is used for taking out, from the polishing device 110, a glass substrate 100 for an information recording medium polished by the polishing device 110 to be used in fine polishing. The invention is not limited to the foregoing embodiments, but may be changed, as necessary. For instance, the suction instrument 1, 200 may also be used for taking out, from a polishing device, a plate-shaped glass member subjected to rough polishing by the polishing device to be used in rough polishing.

In the first embodiment, a contacting pad is formed with a groove serving as a communication path, and in the second embodiment, a suction instrument main body is formed with a main body communication hole serving as a communication path. The suction instrument may be changed, as necessary. For instance, the suction instrument may be configured in such a manner that a contacting pad is formed with a groove, and a suction instrument main body is formed with a main body communication hole.

As a further modification, in the case where a suction instrument is provided with a contacting pad, the contacting pad may be formed only at a location including a periphery of a suction port, so that the through-hole of the glass substrate for an information recording medium and the exterior are communicated with each other by a portion devoid of the contacting pad.

Further, the suction instrument 1, 200 in the foregoing embodiments is formed with the openable and closable operation hole 25, and the glass substrate 100 for an information recording medium as a member to be sucked is mounted/dismounted by opening/closing the operation hole 25. The invention is not limited to the above configuration, but may be changed, as necessary. For instance, the suction instrument 1, 200 may be configured to mount/dismount the glass substrate 100 for an information recording medium by manipulating a suction device by way of an operation switch, without forming the operation hole 25.

The specification discloses the aforementioned configurations. The following is a summary of the main configurations of the embodiments.

A method of manufacturing a glass substrate for an information recording medium according to an aspect is a method of manufacturing a glass substrate for an information recording medium, the glass substrate having a disc shape and formed with a through-hole in a center portion thereof. The method includes a step of polishing a surface of a disc-shaped glass member formed with a through-hole in a center portion thereof by a polishing device to form a glass substrate for an information recording medium; and a step of contacting the polished glass substrate for an information recording medium with a suction instrument, and taking out the glass substrate for an information recording medium from the polishing device in a state that the glass substrate for an information recording medium is sucked by the suction instrument The suction instrument is provided with a suction instrument main body having a suction air passage to be suckingly connected to a suction device, and a suctorial holding portion having a suction port communicating with the suction air passage, the suctorial holding portion being integral with the suction instrument main body. In the step of taking out the glass substrate for an information recording medium from the polishing device, the glass substrate for an information recording medium is sucked by the suctorial holding portion through the suction port of the suctorial holding portion via the suction air passage in response to activation of the suction device in a contacted state that the suctorial holding portion is contacted with the glass substrate for an information recording medium, whereby the glass substrate for an information recording medium is suckingly held by the suctorial holding portion, and the suction instrument is configured to communicate between the through-hole formed in the glass substrate for an information recording medium and the exterior in the contacted state.

In the above configuration, the suction instrument is configured in such a manner that the through-hole formed in the glass substrate for an information recording medium is communicated with the exterior in a state that the suctorial holding portion is contacted with the glass substrate for an information recording medium. Accordingly, in the manufacturing method having the above configuration, it is possible to draw the air into the through-hole of the glass substrate for an information recording medium, in the case where the air in the through-hole is sucked through the suction port in suckingly holding the glass substrate for an information recording medium by the suctorial holding portion. This is advantageous in suppressing suctorial adhesion between the glass substrate for an information recording medium and the polishing pad of the polishing device. Thus, the manufacturing method is advantageous in avoiding intolerable suctorial adhesion of the glass substrate onto the suctorial holding portion, and is advantageous in suppressing fixed adhesion and residue of foreign matter carried by the suctorial holding portion on the surface of the glass substrate for an information recording medium. Further, the manufacturing method is advantageous in easily taking out the glass substrate for an information recording medium from the polishing pad of the polishing device.

Further, according to another aspect, in the aforementioned configuration, preferably, the polishing device may be provided with a polishing pad which polishes the surface of the disc-shaped glass member, and the polishing pad may be so configured as to block the through-hole from one side of the disc-shaped glass member when the polishing pad is placed on the disc-shaped glass member.

In the above configuration, even in the case where a polishing pad having no concave groove on a surface thereof is placed on a plate-shaped glass member, or a polishing pad whose interval between concave grooves is set larger than the diameter of a through-hole of a plate-shaped glass member is placed on the plate-shaped glass member, which may result in blocking the through-hole from one side of the plate-shaped glass member in a region between the concave grooves, it is possible to draw the air into the through-hole through the air passage for external communication by sucking the air in the through-hole in suckingly holding the polished glass substrate for an information recording medium by the suctorial holding portion. Thus, the manufacturing method having the above configuration is advantageous in using various types of polishing pads having high flatness, and in enhancing polishing uniformity.

Further, a suction instrument according to another aspect is a suction instrument provided with a suction instrument main body including a suction air passage to be suckingly connected to a suction device; and a suctorial holding portion having a suction port communicating with the suction air passage and being integral with the suction instrument main body. The suction instrument is configured to suckingly hold a member to be sucked by the suctorial holding portion by sucking the member to be sucked through the suction port of the suctorial holding portion via the suction air passage in response to activation of the suction device in a contacted state that the suctorial holding portion is contacted with the member to be sucked, the member to be sucked having a disc shape and being formed with a through-hole. The suction instrument is configured to communicate between the through-hole formed in the member to be sucked and the exterior in the contacted state.

The suction instrument having the above configuration is configured to communicate between the through-hole formed in the member to be sucked and the exterior in a contacted state that the suctorial holding portion is contacted with the member to be sucked. Accordingly, it is possible to draw the air into the through-hole of the member to be sucked, in the case where the air in the through-hole is sucked through the suction port in suckingly holding the member to be sucked by the suctorial holding portion. This is advantageous in suppressing suctorial adhesion between the member to be sucked and the polishing pad of the polishing device. Thus, the suction instrument having the above configuration is advantageous in avoiding intolerable suctorial adhesion of the member to be sucked onto the suctorial holding portion, and is advantageous in suppressing fixed adhesion and residue of foreign matter carried by the suctorial holding portion on the surface of the member to be sucked. Further, the suction instrument having the above configuration is advantageous in easily taking out the member to be sucked from the polishing pad of the polishing device.

Further, according to another aspect, in the aforementioned configurations, preferably, the suction instrument may be formed with an air passage for external communication, the air passage being configured to communicate between the through-hole formed in the glass substrate for an information recording medium (a member to be sucked) and the exterior in the contacted state, and the air passage for external communication may be provided with a communication port which is opened toward the suctorial holding portion and communicates with the through-hole in the contacted state, and a communication path which communicates between the communication port and the exterior.

In the above configuration, it is possible to communicate between the through-hole formed in the member to be sucked and the exterior with a simplified construction.

Further, according to another aspect, in the suction instrument having the above configuration, preferably, the suctorial holding portion may be provided with a contacting pad which is operable to contact with the glass substrate, the contacting pad may have a center hole which is formed in a center portion thereof, and a groove which extends from the center hole to an end of an outer periphery of the contacting pad in such a manner as to communicate between the center hole and the exterior in the contacted state, the communication port may be constituted of the center hole, and the communication path may be constituted of the groove.

The suction instrument having the above configuration is advantageous in easily forming an air passage for external communication. Further, forming the center hole to have a size substantially equal to the size of the through-hole of the glass substrate for an information recording medium is advantageous in communicating between the center hole and the through-hole of the glass substrate for an information recording medium in using the suction instrument having the above configuration, even in the case where the contacting pad is displaced from a predetermined position with respect to the glass substrate for an information recording medium, whereby the through-hole is communicated with the exterior. Thus, the suction instrument having the above configuration is advantageous in facilitating the operation of suckingly holding the glass substrate for an information recording medium.

Further, according to another aspect, in one of the aforementioned suction instruments, preferably, the suctorial holding portion may be provided with a contacting pad which is operable to contact with the member to be sucked, the contacting pad may have a center hole which is formed in a center portion thereof, the suction instrument main body may be formed with a main body communication hole which passes from the center hole to an outer surface of the suction instrument main body in such a manner as to communicate between the center hole and the exterior in the contacted state, the communication port may be constituted of the center hole, and the communication path may be constituted of the main body communication hole.

The suction instrument having the above configuration is advantageous in securely maintaining a state that the through-hole is communicated with the exterior, without blocking the air passage for external communication, even in the case where the contacting pad is contacted with the glass substrate for an information recording medium with a strong pressing force.

Further, according to another aspect, in one of the aforementioned suction instruments, preferably, the suctorial holding portion may be provided with a contacting pad which is operable to contact with the glass substrate for an information recording medium, the contacting pad may be formed at a location including a periphery of the suction port, and the through-hole formed in the glass substrate for an information recording medium may be communicated with the exterior at the location devoid of the contacting pad.

The suction instrument having the above configuration is advantageous in reducing the area of a contact portion between the suction instrument and the information recording medium. This is advantageous in suppressing damages or adhesion of foreign matter.

This application is based on Japanese Patent Application No. 2010-148937 filed on Jun. 30, 2010, the contents of which are hereby incorporated by reference.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

### INDUSTRIAL APPLICABILITY

The invention provides a method of manufacturing a glass substrate for an information recording medium, and a suction instrument for suckingly holding a member to be sucked by applying a negative pressure.

1. A method of manufacturing a glass substrate for an information recording medium, the glass substrate for an information recording medium having a disc shape and formed with a through-hole in a center portion thereof, the method comprising:
a step of polishing a surface of a disc-shaped glass member formed with a through-hole in a center portion thereof by a polishing device to form a glass substrate for an information recording medium; and
a step of contacting the polished glass substrate for an information recording medium with a suction instrument, and taking out the glass substrate for an information recording medium from the polishing device in a state that the glass substrate for an information recording medium is sucked by the suction instrument, wherein
the suction instrument is provided with a suction instrument main body having a suction air passage to be suckingly connected to a suction device, and a suctorial holding portion having a suction port communicating with the suction air passage, the suctorial holding portion being integral with the suction instrument main body,
in the step of taking out the glass substrate for an information recording medium from the polishing device, the glass substrate for an information recording medium is sucked by the suctorial holding portion through the suction port of the suctorial holding portion via the suction air passage in response to activation of the suction device in a contacted state that the suctorial holding portion is contacted with the glass substrate for an information recording medium, whereby the glass substrate for an information recording medium is suckingly held by the suctorial holding portion, and
the suction instrument is configured to communicate between the through-hole formed in the glass substrate for an information recording medium and the exterior in the contacted state.

2. The manufacturing method according to claim 1, wherein
the polishing device is provided with a polishing pad which polishes the surface of the disc-shaped glass member, and
the polishing pad is so configured as to block the through-hole from one side of the disc-shaped glass member when the polishing pad is placed on the disc-shaped glass member.

3. The manufacturing method according to claim 1, wherein
the suction instrument is formed with an air passage for external communication, the air passage being configured to communicate between the through-hole formed in the glass substrate for an information recording medium and the exterior in the contacted state, and
the air passage for external communication is provided with a communication port which is opened toward the suctorial holding portion and communicates with the through-hole in the contacted state, and a communication path which communicates between the communication port and the exterior.

4. The manufacturing method according to claim 3, wherein the suctorial holding portion is provided with a contacting pad which is operable to contact with the glass substrate for an information recording medium,
the contacting pad has a center hole which is formed in a center portion thereof, and a groove which extends from the center hole to an end of an outer periphery of the contacting pad in such a manner as to communicate between the center hole and the exterior in the contacted state, the communication port is constituted of the center hole, and
the communication path is constituted of the groove.

5. The manufacturing method according to claim 3, wherein
the suctorial holding portion is provided with a contacting pad which is operable to contact with the glass substrate for an information recording medium,
the contacting pad has a center hole which is formed in a center portion thereof,
the suction instrument main body is formed with a main body communication hole which passes from the center hole to an outer surface of the suction instrument main body in such a manner as to communicate between the center hole and the exterior in the contacted state, the communication port is constituted of the center hole, and
the communication path is constituted of the main body communication hole.

6. The manufacturing method according to claim 1, wherein
the suctorial holding portion is provided with a contacting pad which is operable to contact with the glass substrate for an information recording medium,
the contacting pad is formed at a location including a periphery of the suction port, and
the through-hole formed in the glass substrate for an information recording medium is communicated with the exterior at the location devoid of the contacting pad.

7. A suction instrument, comprising:
a suction instrument main body including a suction air passage to be suckingly connected to a suction device; and
a suctorial holding portion having a suction port communicating with the suction air passage and being integral with the suction instrument main body, wherein
the suction instrument is configured to suckingly hold a member to be sucked by the suctorial holding portion by sucking the member to be sucked through the suction port of the suctorial holding portion via the suction air passage in response to activation of the suction device in a contacted state that the suctorial holding portion is contacted with the member to be sucked, the member to be sucked having a disc shape and being formed with a through-hole, and
the suction instrument is configured to communicate between the through-hole formed in the member to be sucked and the exterior in the contacted state.

8. The suction instrument according to claim 7, wherein
the suction instrument is formed with an air passage for external communication, the air passage being configured to communicate between the through-hole formed in the member to be sucked and the exterior, and
the air passage for external communication is provided with a communication port which is opened toward the suctorial holding portion and communicates with the through-hole in the contacted state, and a communication path which communicates between the communication port and the exterior.

9. The suction instrument according to claim 8, wherein
the suctorial holding portion is provided with a contacting pad which is operable to contact with the member to be sucked,
the contacting pad has a center hole which is formed in a center portion thereof, and a groove which extends from the center hole to an end of an outer periphery of the contacting pad in such a manner as to communicate between the center hole and the exterior in the contacted state,
the communication port is constituted of the center hole, and
the communication path is constituted of the groove.

10. The suction instrument according to claim 8, wherein
the suctorial holding portion is provided with a contacting pad which is operable to contact with the member to be sucked,
the contacting pad has a center hole which is formed in a center portion thereof,
the suction instrument main body is formed with a main body communication hole which passes from the center hole to an outer surface of the suction instrument main body in such a manner as to communicate between the center hole and the exterior in the contacted state,
the communication port is constituted of the center hole, and
the communication path is constituted of the main body communication hole.

11. The suction instrument according to claim 7, wherein
the suctorial holding portion is provided with a contacting pad which is operable to contact with the member to be sucked,
the contacting pad is formed at a location including a periphery of the suction port, and the through-hole formed in the member to be sucked is communicated with the exterior at the location devoid of the contacting pad.
